(19) United States
(12) Patent Application Publication
(10) Pub. No.: US 2019/0293019 A1
(43) Pub. Date: Sep. 26, 2019

(54) NACELLE EQUIPPED WITH A REVERSER SYSTEM COMPRISING DOORS AND SYSTEMS FOR LOCKING THE DOORS IN THE STOWED POSITION

(71) Applicant: Airbus Operations SAS, Toulouse (FR)

(72) Inventors: Frédéric RIDRAY, L'ISLE JOURDAIN (FR); Frédéric PIARD, TOURNEFEUILLE (FR)

(21) Appl. No.: 16/359,456

(22) Filed: Mar. 20, 2019

(30) Foreign Application Priority Data
Mar. 23, 2018 (FR) 1852536

(51) Int. Cl. F02K 1/70; F02K 1/56; F02K 1/76; B64D 33/04

(52) U.S. Cl. CPC F02K 1/70; B64D 33/04; F02K 1/766; F02K 1/56

(57) ABSTRACT

A nacelle for a bypass turbojet engine having a secondary flow path, the nacelle exhibiting an open window between the secondary flow path and the outside of the nacelle and comprising a reverser system comprising doors in which each door is able to move between a stowed position in which the door closes off the window and a deployed position in which the door does not close off the window. For each door, at least one locking system is configured to lock the door in the stowed position, to unlock the door automatically when the door leaves its stowed position and to lock the door automatically when the door arrives in its stowed position.

### CROSS-REFERENCES TO RELATED APPLICATIONS

This application claims the benefit of the French patent application No. 1852536 filed on Mar. 23, 2018, the entire disclosures of which are incorporated herein by way of reference.

### FIELD OF THE INVENTION

The present invention relates to a nacelle of a bypass turbojet engine which is equipped with a reverser system comprising doors able to move between a stowed position and a deployed position and to a locking system which is configured to lock the doors in the stowed position, to a bypass turbojet engine comprising such a nacelle, and to an aircraft comprising at least one such bypass turbojet engine.

### BACKGROUND OF THE INVENTION

A bypass turbojet engine of the prior art has an engine in the form of a core and a nacelle surrounding the engine. Such a bypass turbojet engine is fitted to an aircraft which, under each wing, has a pylon fixed under the wing and bearing the bypass turbojet engine. The bypass turbojet engine comprises, between the nacelle and the engine, a secondary flow path through which a secondary, or bypass, stream flows.

In order to reverse the thrust of the bypass turbojet engine, the nacelle is equipped with a reverser system which comprises doors which are able to move between a stowed position and a deployed position. In the deployed position, the doors position themselves across the secondary flow path so as to deflect the bypass stream outwards and towards the front of the nacelle.

In the stowed position, the doors are subjected to high pressures, and they may start to vibrate, which may generate disagreeable noise, and it is therefore necessary to find a system to prevent such vibrations.

### SUMMARY OF THE INVENTION

It is an object of the present invention to propose a nacelle for a bypass turbojet engine which is equipped with a reverser system with doors able to move between a stowed position and a deployed position and, for each door, a locking system which locks the door in the stowed position in order to avoid vibrations.

To this end, there is proposed a nacelle for a bypass turbojet engine having a secondary flow path, the nacelle exhibiting an open window between the secondary flow path and the outside of the nacelle and comprising a reverser system comprising doors in which each door is able to move between a stowed position in which the door closes off the window and a deployed position in which the door does not close off the window and, for each door, at least one locking system configured to lock the door in the stowed position, to unlock the door automatically when the door leaves its stowed position and to lock the door automatically when the door arrives in its stowed position.

Such a nacelle makes it possible to limit the vibrations of the doors when they are in the stowed position and before they begin to deploy.

Advantageously, each locking system comprises a shoe fixed to the door, a stud facing away from the door and having a restriction between its base fixed to the shoe and its tip, two jaws fixed to the nacelle via an elastic support and able to move between a parted position in which the distance between the two jaws is greater than the width of the tip of the stud and a contracted position in which the distance between the two jaws is less than the width of the tip of the stud.

Advantageously, each elastic support is a spring leaf.

Advantageously, each jaw adopts the form of a cylinder, the axis of which is perpendicular to the axis of the stud.

The invention also proposes a bypass turbojet engine comprising an engine and a nacelle according to one of the preceding alternative forms and which surrounds the engine and therewith defines a secondary flow path.

The invention also proposes an aircraft comprising at least one bypass turbojet engine according to the preceding alternative form.

### BRIEF DESCRIPTION OF THE DRAWINGS

The abovementioned features of the invention, together with others, will become more clearly apparent from reading the following description of one embodiment, the description being given in connection with the attached drawings, among which:

FIG. 1 is a side view of an aircraft comprising a bypass turbojet engine according to the invention,

FIG. 2 is a perspective view of a bypass turbojet engine according to one particular embodiment of the invention when the thrust reverser system is not activated,

FIG. 3 is a perspective view of the bypass turbojet engine of FIG. 2 when the thrust reverser system is activated,

FIG. 4 is a perspective view of a door equipped with two locking systems according to the invention, and

FIG. 5 is a perspective view of a locking system for a nacelle according to the invention.

### DETAILED DESCRIPTION OF THE PREFERRED EMBODIMENTS

In the description which follows, terms relating to a position are considered with reference to the direction of travel of an aircraft.

FIG. 1 shows an aircraft 10 which comprises a fuselage 12 on each side of which is fixed a wing 14 which bears at least one bypass turbojet engine 100 according to the invention. The bypass turbojet engine 100 is fixed under the wing 14 by means of a pylon 16.

In the description which follows, and by convention, the longitudinal axis of the bypass turbojet engine 100, which is parallel to the longitudinal axis of the aircraft 10 and oriented positively towards the front of the aircraft 10, is referred to as X, the transverse axis which is horizontal when the aircraft 10 is on the ground is referred to as Y, and the axis which is vertical when the aircraft 10 is on the ground is referred to as Z, these three directions X, Y and Z being mutually orthogonal.

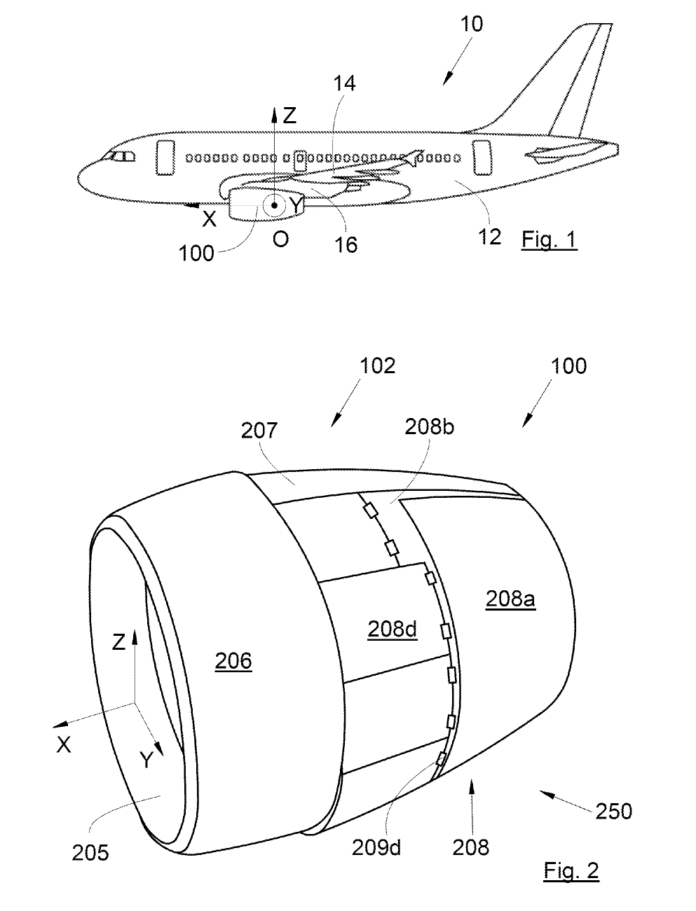

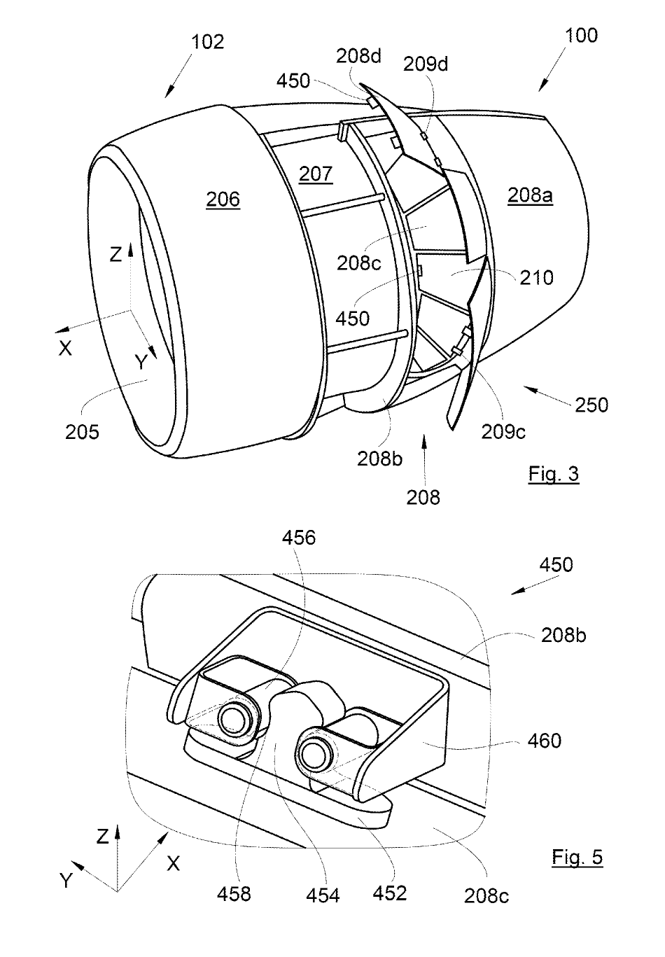

FIGS. 2 and 3 show the bypass turbojet engine 100 according to one particular embodiment of the invention.

The bypass turbojet engine 100 has a nacelle 102, an engine which is housed inside the nacelle 102, in the form of a core, and a fan casing 206 at the front of the nacelle 102.

The nacelle 102 comprises a reverser system 250 which is retracted in FIG. 2 and deployed in FIG. 3.

The bypass turbojet engine 100 has, between the nacelle 102 and the engine, a secondary flow path through which there circulates a secondary or bypass stream coming from the air inlet 205, through a fan and which therefore flows in a flow direction which runs from the front towards the rear of the aircraft 10.

The nacelle 102 has a fixed structure 207 which is mounted fixedly on the fan casing 206.

The reverser system 250 has a mobile assembly 208 which comprises a mobile cowl 208a forming the walls of the nozzle and a frame 208b. The frame 208b here takes the form of a cylinder with perforated walls. The mobile cowl 208a is fixed to the frame 208b.

There are two mobile cowls 208a, positioned one on each side of a mid-plane of the bypass turbojet engine 100, each one constituting an outer cowl of the nacelle 102 and overall, they form a cylinder which constitutes the external wall of the secondary flow path.

The mobile assembly 208, by means of the frame 208b, is mounted with the ability to move translationally in a direction of translation roughly parallel to the longitudinal axis X on the fixed structure 207 of the nacelle 102.

The translational movement of the frame 208b, and therefore of the mobile assembly 208, is achieved by any suitable slideway system such as, for example, slideways between the fixed structure 207 and the frame 208b. Likewise, a first mechanical-transmission system of the reverser system 250 is fixed to the fixed structure 207 to move the frame 208b. The first mechanical-transmission system comprises, for example, actuators such as cylinder actuators, motors, racks, etc. The first mechanical-transmission system is operated by a control unit of the aircraft 10 and is not described further in detail, because it may adopt various forms within the competence of a person skilled in the art.

The mobile assembly 208 also comprises reverser doors 208c-d which are mounted articulated on the frame 208b and which in the embodiment of the invention presented here comprise inner doors 208c and outer doors 208d.

The doors 208c-d are positioned at the front in relation to the mobile cowl 208a.

In the embodiment of the invention presented here, each inner door 208c is mounted articulated on the frame 208b between a stowed position and a deployed position (FIG. 3) and vice versa. The passage from the stowed position to the deployed position is achieved by rotating the inner door 208c towards the inside of the turbojet engine 100.

Each inner door 208c here is articulated via a rear edge to the frame 208b by hinges 209c fixed to the frame 208b, while the opposite free edge positions itself facing towards the front in the stowed position and across the secondary flow path and towards the engine in the deployed position.

The outer doors 208d are positioned on the outside with respect to the inner doors 208c. Each outer door 208d is mounted facing an inner door 208c and the outer door 208d and the inner door 208c facing it constitute a pair of doors. The reverser system 250 thus comprises a plurality of pairs of doors 208c-d.

Each outer door 208d is mounted articulated on the frame 208b between a stowed position (FIG. 2) and a deployed position (FIG. 3) and vice versa. The passage from the stowed position to the deployed position is achieved by rotating the outer door 208d towards the outside of the turbojet engine 100. When the inner doors 208c and the outer doors 208d are deployed, they overall achieve continuity that allows the secondary or bypass stream to be deflected outwards and towards the front of the nacelle 102.

Each outer door 208d is articulated by a rear edge to the frame 208b by hinges 209d fixed to the frame 208b, while the opposite free edge positions itself facing forwards in the stowed position and facing outwards in the deployed position.

In the stowed position, the outer doors 208d are positioned between the mobile cowl 208a and the fan casing 206, so as to constitute an outer wall of the nacelle 102, which is therefore in contact with the stream of air flowing around the nacelle 102.

The passage of each door 208c-d from the stowed position into the deployed position and vice versa is achieved by a second mechanical-transmission system of the reverser system 250, comprising, for example, a motor, a cylinder actuator, a rack system, etc. The second mechanical-transmission system is operated by a control unit of the aircraft 10 and is not described further in detail because it may adopt various forms within the competence of the person skilled in the art.

The mobile assembly 208, and therefore the frame 208b, is able to move between a forward position (FIG. 2) and a retracted position (FIG. 3) and vice versa. In the forward position, the mobile assembly 208, and therefore the frame 208b, is positioned as far forward as possible so that the outer doors 208d, which are in the stowed position, are close in to the fan casing 206. In the retracted position, the mobile assembly 208, and therefore the frame 208b, is positioned as far back as possible so that the outer doors 208d are distanced away from the fan casing 206.

In the forward position, the outer doors 208d extend the fan casing 206 rearwards and, in the same way, the mobile cowl 208a extends the outer doors 208d rearwards.

The doors 208c-d can adopt the stowed position when the frame 208b is in the forward position or in the retracted position. The doors 208c-d can adopt the deployed position only when the frame 208b is in the retracted position.

The passage of the frame 208b from the forward position to the position in which the frame 208b is retracted and the doors 208c-d are deployed therefore involves, starting from the forward position of the frame 208b and therefore the stowed positions of the doors 208c-d, activating the first mechanical-transmission system to retract the frame 208b in a translational movement with respect to the fixed structure 207 in order to reach the position in which the frame 208b is retracted and the doors 208c-d are stowed, then activating each second mechanical-transmission system to move each door 208c-d from the stowed position into the deployed position.

The reverse movement allows a return to the stowed and forward position.

In the retracted position, the nacelle 102 has an open window 210 between the secondary flow path and the outside of the nacelle 102 and which is delimited at the front by the fixed structure 207 and at the rear by the mobile cowl 208a. In the stowed position, the doors 208c-d close off the window 210, and in the deployed position, the doors 208c-d do not close off the window 210 and leave it open, which means that air from the secondary or bypass stream can pass through the window 210 to reach the outside of the bypass turbojet engine 100.

When the doors 208c-d are in the deployed position, the secondary or bypass stream is deflected towards the outside of the nacelle 102 and towards the front, making it possible to generate a reverse thrust.

According to another embodiment which has not been depicted, the nacelle comprises no mobile cowl and the doors are pivot-mounted on the fixed structure which has a window which is closed off by the doors in the stowed position and open between the secondary flow path and the outside when the doors are in the deployed position.

Likewise, in the embodiment of the invention presented here, there is an outer door and an inner door to deflect the secondary or bypass stream, but it is possible to provide just one inner door articulated at a rear edge and cascade vanes, or a hybrid door which extends across the secondary flow path and to the outside of the nacelle when it is in the deployed position. In this last instance, the axis of rotation of the hybrid door is not at a rear edge but in a middle portion of the hybrid door.

In general, each door is mounted articulated between a stowed position in which it does not lie across the secondary flow path and a deployed position in which it lies across the secondary flow path.

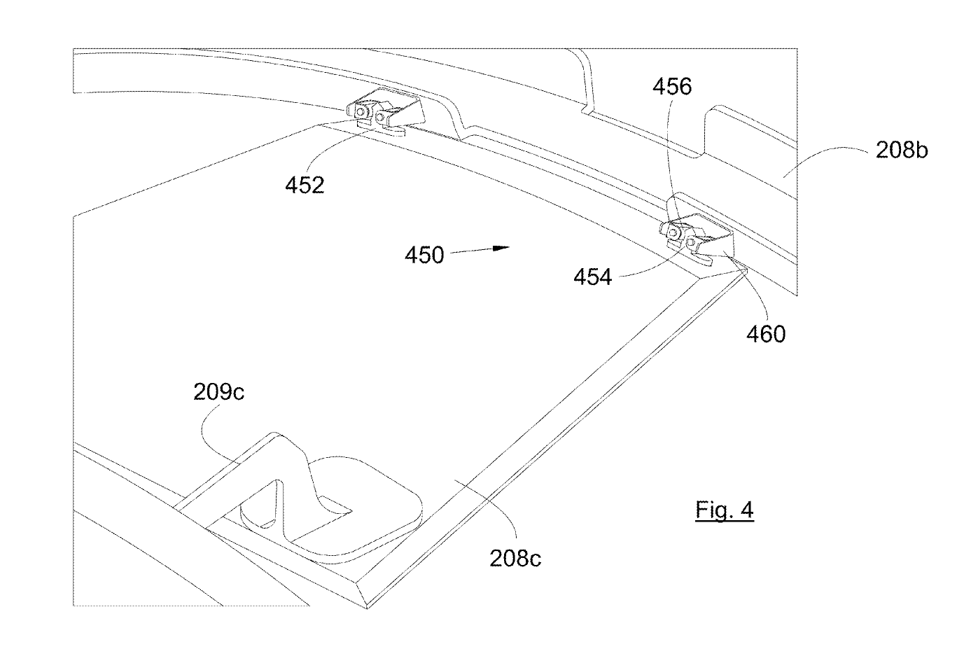

FIG. 4 shows an inner door 208c in the stowed position, here on the frame 208b, but which can be the fixed structure when there is no mobile frame.

The invention is now described more particularly in the case of an inner door 208c, but may also apply to an outer door 208d as shown schematically in FIG. 3.

The inner door 208c has two locking systems 450, one of which has been enlarged in FIG. 5. Increasing the number of locking systems 450 makes it possible to achieve better locking, but leads to an increase in the weight and the need for a greater unlocking force, and it is therefore necessary to reach a compromise regarding the number of locking systems 450.

The locking system 450 is configured to lock the inner door 208c in the stowed position, to unlock the door 208c automatically when the inner door 208c leaves its stowed position to move towards the deployed position, and to lock the door 208c automatically when the inner door 208c arrives at its stowed position from the deployed position. The unlocking of the inner door 208c occurs automatically when a force above a threshold is exceeded. In the same way, the locking of the inner door 208c is achieved automatically when a force above a threshold is exceeded.

The locking system 450 comprises a shoe 452 fixed to the inner door 208c and, more particularly here, to that face of the inner door 208c that faces towards the outside of the nacelle 102. In the case of an outer door 208d, the shoe 452 is fixed to that face of the outer door 208d that faces towards the inside of the nacelle 102. In general, the shoe 452 is fixed to that face that faces away from the direction from the stowed position towards the deployed position.

The shoe 452 bears a stud 454 facing away from the inner door 208c and having a restriction 458 between its base fixed to the shoe 452 and its tip. The axis of the stud 454 is roughly perpendicular to the inner door 208c.

The locking system 450 also comprises two jaws 456 fixed to the frame 208b and more generally to the nacelle 102, each one here having the form of a cylinder, the axis of which is perpendicular to the axis of the stud 454. The jaws 456 are able to move between a parted position in which the distance between the two jaws 456 is greater than the width of the tip of the stud 454 and a constricted position in which the distance between the two jaws 456 is less than the width of the tip of the stud 454.

When there is no mobile cowl, the jaws 456 are fixed to the fixed structure.

Each jaw 456 is mounted on the frame 208b via an elastic support 460 which in this embodiment is a spring leaf. The threshold for unlocking and locking corresponds to the force needed to part the jaws 456.

In the locked position, the jaws 456 clamp the stud 454 at its restriction 458 when the inner door 208c is in the stowed position. Thus, the inner door 208c does not vibrate when it is in the stowed position.

When the inner door 208c is subjected by the second mechanical-transmission system to a force that tends to move it towards the deployed position, the stud 454 moves and the tip of the stud 454 parts the jaws 456 because of the flexibility of each elastic support 460. The tip can then leave the jaws 456 and the inner door 208c is unlocked and can move freely towards the deployed position.

Conversely, when the inner door 208c is subjected by the second mechanical-transmission system to a force that tends to move it towards the stowed position, the stud 454 moves and the tip of the stud 454 penetrates between the jaws 456, parting them because of the flexibility of each elastic support 460. The tip can then re-emerge out of the other side of the jaws 456 and the jaws 456 constrict onto the restriction 458 and the inner door 208c is locked in the stowed position.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A nacelle for a bypass turbojet engine having a secondary flow path, the nacelle comprising:
an open window between the secondary flow path and the outside of the nacelle,
a reverser system comprising doors in which each door is able to move between a stowed position in which the door closes off the window and a deployed position in which the door does not close off the window and,
for each door, at least one locking system configured to lock the door in the stowed position, to unlock the door automatically when the door leaves its stowed position and to lock the door automatically when the door arrives in its stowed position,
each locking system comprising:
a shoe fixed to the door,
a stud facing away from the door,
a restriction between a base of the stud which is fixed to the shoe and a tip of the stud, and
two jaws fixed to the nacelle via an elastic support and configured move between a parted position in which a distance between the two jaws is greater than a width of the tip of the stud and a contracted position in which the distance between the two jaws is less than the width of the tip of the stud.

2. The nacelle according to claim 1, wherein each elastic support is a spring leaf.

3. The nacelle according to claim 1, wherein each jaw has a cylindrical form, an axis of which is perpendicular to an axis of the stud.

4. A bypass turbojet engine comprising an engine and a nacelle according to claim 1 which surrounds the engine and therewith defines the secondary flow path.

5. An aircraft comprising at least one bypass turbojet engine according to claim 4.

6. A nacelle for a bypass turbojet engine having a primary flow path through a core of the engine and a secondary flow path bypassing the core and within the nacelle, the nacelle comprising:
an opening through at least one wall of the nacelle between the secondary flow path and an outside of the nacelle,
a reverser system comprising doors in which each door is able to move between a stowed position in which the door closes off the opening and a deployed position in which the door does not close off the opening and,
at least one locking system for each door configured to lock the respective door in the stowed position, to unlock the door automatically when the door leaves the stowed position and to lock the door automatically when the door arrives in the stowed position, the locking system comprising:
a stud fixed at a base to the door and extending away from the door,
a narrowing of the stud between the base of the stud and a tip region of the stud, and
two jaws fixed to the nacelle via an elastic support and configured to move between a parted position in which a distance between the two jaws is at least as great as a width of the tip region of the stud and a contracted position in which the distance between the two jaws is less than the width of the tip region of the stud.

7. The nacelle according to claim 6, wherein the locking system comprises a shoe fixed to the door, with the shoe fixing the stud, at the base thereof, to the door.

8. The nacelle according to claim 6, wherein the stud is fixed to a face of the door that faces towards the outside of the nacelle.

9. The nacelle according to claim 6, wherein the stud is fixed to a face of the door that faces in a direction from the stowed position towards the deployed position.

10. The nacelle according to claim 6, wherein the stud has an axis arranged substantially perpendicular to the door.

11. The nacelle according to claim 10, wherein each jaw comprises a cylinder having an axis which is perpendicular to the axis of the stud.

12. The nacelle according to claim 6, wherein the stud has a narrowed width at a distal end of the stud opposite the base.

13. The nacelle according to claim 6, wherein a threshold for unlocking and locking the locking system comprises a force required to move the jaws apart against a force of the elastic support.
